(19) United States
(12) Patent Application Publication
(10) Pub. No.: US 2005/0160433 A1
(43) Pub. Date: Jul. 21, 2005

(54) Optimizations of user interface-independent testing

(76) Inventors: John Robert Lambert, Bellevue, WA (US); Keith B. Stobie, Bellevue, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(21) Appl. No.: 10/761,666

(22) Filed: Jan. 21, 2004

(51) Int. Cl. G06F 9/44

(52) U.S. Cl. 719/328

(57) ABSTRACT

A method of testing an application program for multiple interfaces includes identifying one or more APIs that are common among the multiple interfaces. A test program for testing the application program at least with respect to the common API can be designed around the identified, common API. One or more values, such as a value and/or the value's isomorphisms, can be input into the test program so that a robust determination can be inferred from the output of the application program. The test program can be reconfigured easily for different APIs, thereby significantly minimizing the amount of testing that needs to be done, as well as the number of test programs that need to be written for an application program that can be accessed through multiple interfaces.

### BACKGROUND OF THE INVENTION

1. The Field of the Invention

This invention relates to systems, methods, and computer program products for testing applications that can be accessed through multiple user interfaces.

2. Background and Relevant Art

Computerized, electronic systems are increasingly common, in part because such computerized systems automate much of what people previously had to perform manually. Accordingly, computerized systems have added a certain amount of efficiency to people's ability to perform tasks.

In general, computerized systems can comprise a wide variety of devices such as desktop or laptop computers, personal digital assistants, wireless and corded telephones, televisions, software applications, and even such seemingly mundane devices as toasters, and refrigerators. Generally, computerized systems are configured to accomplish these ends by being configured to run a set of computerized instructions, such as an operation system. As such, the computerized system should be able to read and execute operating system (OS) or platform specific executable instructions that cause the computerized system to perform the function.

The process of generating executable instructions for a computerized system is somewhat involved. Ordinarily, a software developer must first think of the desired functions or results that the executable instructions should perform, and then enter corresponding text-format instructions into an electronic text file, typically in the form of programming source code. In some cases, such as with interpreted programming languages (e.g., Javascript, Perl, etc.), a computerized system directly interprets entered text-format instructions, and performs the desired function. In other cases, such as with compiled programming languages (e.g., C#—pronounced “C sharp”, C++, etc.), text-format instructions are first compiled into object or machine codes that the computerized system can execute. Thus, executable instructions can be text-format instructions that are “interpreted” and run, or can be compiled object or machine codes that are executed and run.

After a software developer creates executable instructions, a device manufacturer or end user must then enter or load the executable instructions into a computerized system for the instructions to be useful. This may be done through a variety of means including running an executable install file from a CDROM, downloading the executable instructions from a local or wide area network file server (e.g., Internet website), or wireless uplink, etc. Of course, however the instructions are loaded into the computerized system, for loaded executable instructions to be useful, the computerized system must be able to read the loaded executable instructions (hereinafter referred to as a “software program”), and a user should be able to implement the executable instructions as the developer intended.

Computerized systems, however, can be less efficient for a desired function, or may not even be able to perform a desired function at all, when the underlying software program fails to operate as intended. Failure to operate as intended can result from inadequacies in the software development process, which can lead to a situation where the software program malfunctions (often referred to as “bugs”) when it is executed. Software program malfunctions may be based on situations as mundane as minor misspellings in an operator or an operand, such as when a software developer misspells words or phrases in text-format instructions that are necessary to perform a function when the software program is executed.

Other software malfunctions in a software program can be more complex, such as an incorrectly designed series of functions. For example, the software developer could accidentally condition a result on the wrong function, or could accidentally point a first function to filter intermediate results into the wrong recipient function, hence making the function processing work out of order. However complex or mundane the source of the malfunction, the typical software developer must often therefore spend significant time trying to identify and correct errors in the developed programs.

Not surprisingly, software developers may use a variety of testing methods in order to catch errant program functions or results, when the program is in putative working form. For example, a software developer may designate a person that manually inputs data into a particular interface that accesses the desired program. The tester might then check to see if the program returns the desired result based on the input data. For example, to ensure that a Graphical User Interface (“GUI”) is appropriately interoperating with a calculator function, the tester might open up the GUI, and try and input the numbers 2 and 2, and then select the “add” command. If selecting the “add” command produces an error message, or if the GUI returns an incorrect result such as the number 10, the tester will understand that there has been a malfunction at some level in the developed program.

At least one problem with this manner of testing a program is that it can be fairly difficult for a tester to think of every possible way in which a program can be tested. For example, a calculator program could have an error that only occurs with a limited subset of input values. If the tester is manually testing individual numbers, it would be inefficient, and/or impossible for the tester to think of every number and every available mathematical operation in order to flesh out any programmatic errors. In some cases, such as with “test automation”, the software developer may write a secondary testing program that the tester could use to test for many of the possible inputs in a relatively short time. While this can provide some benefits, it can be a burden to write program-specific tests for each newly written program.

In addition, software developers will often write programs such as the above-described calculator example that can be accessed through multiple different types of interfaces. For example, a software developer may write a calculator program that can be accessed through multiple user interfaces, such as through a GUI on a desktop or handheld computer, through a touch-tone telephone interface, through a command-line interface, through some other audio or visual interface, and so forth. Often, each such user interface will be designed to access the application program through a set of APIs, which may be unique to the user interface, and/or to the application program.

Even if the software developer has written a secondary testing program to deal with an application program as accessed through a GUI on a desktop computer, the tester may not necessarily be able to apply the test through other interfaces and/or computerized systems. Furthermore, if the software developer writes an update to one of the testing programs, the software developer may not be able to apply the update to each different program-specific test, and so may be required to write a separate, new update for each program-specific test. Accordingly, software developers will often need to write multiple testing programs for multiple functions and for multiple individual interfaces that will access a given program or API.

Accordingly, what would be advantageous are systems, methods, and computer program products for testing application programs independent of the interface used to access the application program.

### BRIEF SUMMARY OF THE INVENTION

Embodiments of the present invention solve one or more of the foregoing problems by providing systems, methods, and computer program products for program tests that can be implemented for a variety of user interfaces without otherwise testing the program through each user interface. In particular, embodiments of the present invention simplify the testing process by providing program tests that do not need to be rewritten when implemented across a broad spectrum of interfaces and computerized systems.

At least one embodiment of the present invention involves identifying an application program to be tested, and identifying one or more interfaces that are configured to access the application program. Typically, each interface that accesses the application program, such as a user interface also implements one or more APIs that are common from one interface that accesses the application program to the next interface that accesses the application program. Accordingly, the present invention also comprises identifying an application program interface that is common to each of the one or more interfaces. Once identifying a common API for each interface, a test program can be configured around the common API in order to access the program of interest by the test program though the identified API. In some cases, a test written for one API can be configured around another API, or around the first API for other application programs, and so forth.

A value can then be provided to the application program by the test program through the identified, common API. In some implementations, several variations on the same value (e.g., “isomorphisms”) are passed through the identified, common API into the application program. This can be done on an essentially automatically determined and per-interface basis, such that all given isomorphisms for any given interface can be tested automatically from one interface to the next. In any case, if the application program operates on the passed value as intended, both the identified, common API and the application program can be understood to be functional, and/or interoperable. Accordingly, implementations of the present invention allow an application to be tested for multiple interfaces by passing values to only a single test, or relatively far fewer numbers of tests than otherwise required in the present state of the art.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an overview perspective in which one or more interfaces are configured to access an application program in accordance with at least one embodiment of the present invention;

FIG. 2 illustrates one aspect of the present invention in which one or more test programs pass one or more values to one or more application programs in accordance with at least one embodiment of the present invention;

FIG. 3 illustrates a method for testing an application program for one or more user interfaces in accordance with at least one embodiment of the present invention;

FIG. 4 illustrates a method for testing an application program with respect to results obtained for one or more user interfaces in accordance with at least one embodiment of the present invention and

FIG. 5 illustrates a suitable environment for practicing embodiments of the present invention.

### DETAILED DESCRIPTION OF THE PREFERRED EMBODIMENTS

The present invention extends to both methods and systems for simplifying a program testing process by providing program tests that do not need to be rewritten when implemented across a broad spectrum of interfaces and computerized systems. The embodiments of the present invention may comprise a special purpose or general-purpose computer including various computer hardware, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer.

When information is transferred or provided over a network or another communications connection (either hardwired, wireless, or a combination of hardwired and wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

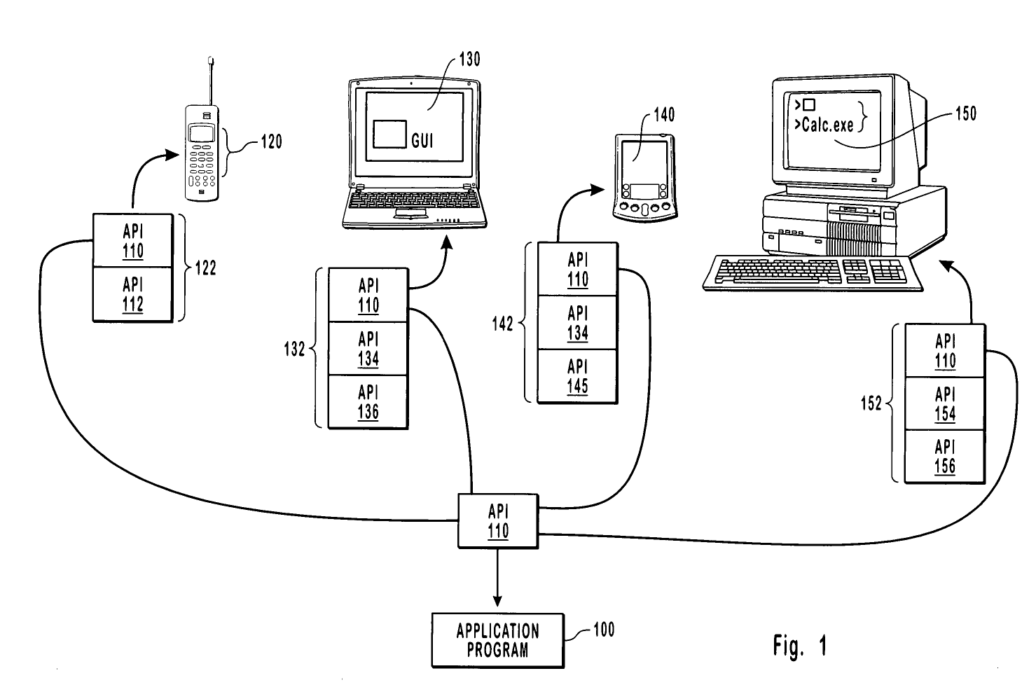

FIG. 1 shows an overview of aspects of the present invention in which one or more interfaces, such as one or more user interfaces, are used to access an application program 100. In particular, a “user interface” for the purposes of this specification and claims will be understood broadly to include such interfaces as a user interface 120 for a mobile phone, a user interface 140 for a Personal Digital Assistant or (“PDA”), a Graphical User Interface (“GUI”) 130 for a desktop or related computer system, a command line user interface 150 for a desktop or related computer system, and so forth.

Interfaces can be directed to receiving and/or interpreting textual input, such as by entering keystrokes on a keyboard that is attached to a computerized system, and/or can be directed to receiving audio commands as input.

A user interface could also include interfaces for a home entertainment system (not shown), such as an on-screen television program guide (not shown), and so forth.

Moreover, a “user interface” for the purposes of this specification and claims is not limited to devices or application programs that require human interaction, and so can further include machine interfaces and so forth such as automated systems that access application programs through an electronic interface. As described herein, therefore, one will appreciate that there can be many types of interfaces for accessing a given application program; and, hence, the interfaces and applications described herein are merely exemplary.

Generally, an interface, such as a GUI 130, will comprise executable program code that allows a user to request a relevant computerized system to perform a task. In typical operation, a user requests a task through the interface by some physical act such as by entering keystrokes through a keyboard, speaking a command, or by selecting an actionable item with a mouse device. In turn, each such user interface will execute the user's valid requests by executing any variety of application program interfaces (“API”), which are can often be interface-specific. These sets of APIs can include system or interface-specific APIs, as well as APIs that are specific for accessing an application program, such as accessing a calculator program remotely over a telephone interface.

For example, telephone 120 may implement a set of APIs 122 such as API 110 and API 112. Graphical user interface 130 may alternatively implement a set of APIs 132 such as API 110, API 134, and API 136. Similarly, personal digital assistant 140 may implement a set of APIs 142 such as API 110, API 144, API 146, and command line interface 150 can implement a set of APIs 152 such as API 110, API 154, and API 156. API 110 may be specific for accessing a calculator or date program through a wireless protocol. As well, API 134 may be specific for displaying the output of the calculator or date program within a graphical interface. However configured, the user interface API's implement the user's request directly to an application program, such as by making a function call to an application program that is accessible through the relevant computer's operating system.

As also shown in FIG. 1, each of the API sets 122, 132, 142, and 152 that are used in the user interface for each associated computerized system includes at least one common API, such as API 110. In particular, each interface that accesses an application program often does so through a common one or more APIs that are configured to access the application program. As will be shown herein, this common API 110 can then be used as part of a test program (not shown) for testing the relevant application program for which the API is configured. Testing the application program using a common API is advantageous since test results for the application program can be understood for each of the different interfaces and/or computerized systems, without requiring multiple tests to be written.

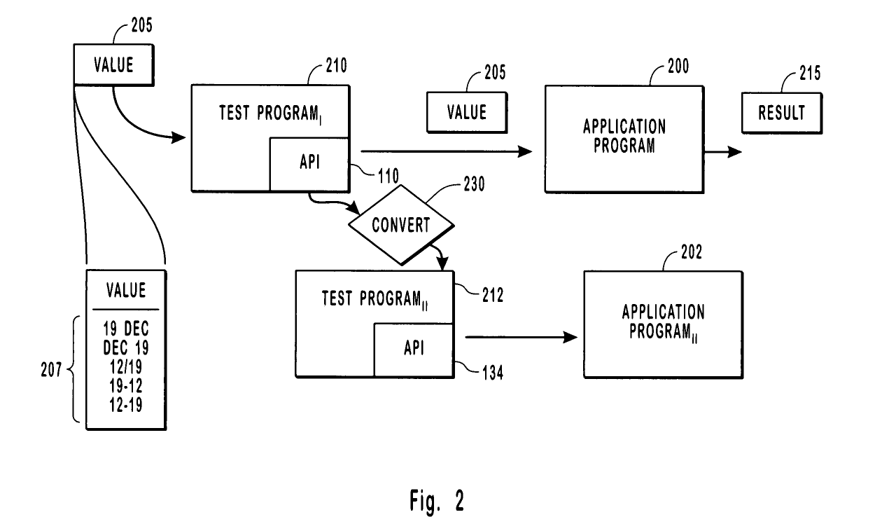

FIG. 2 shows an overview system for testing an Application Program, such as Application Program 200 using an identified common API 110. For example, a program developer first designs a test program 210 that includes one or more program calls from the identified common API 110 to the Application Program 200. The test program 210 can be any type of computerized instructions including interpreted text for use in a computerized interpreter as well as source code that is compiled into an executable file. Any combination of the foregoing is possible depending on the needs of the tester or program developer. The tester then tests the Application Program 200 through the API 110 with one or more values 205. As will be understood after reading this disclosure and claims, a “tester” will be understood to mean any automated or non-automated entity that can input a value into an application program through a test program, and in some cases, analyze the output of the application program.

The value 205 in some embodiments can be tested with the API 110 as a single value, such as the single date value 12-19 when used in, for example, a calendar Application Program 200. In other embodiments, the value 205 can be tested in various isomorphisms 207 so that every iterative form of the value 205 can be covered. For the purposes of this description and claims, an “isomorphism” refers generally to one or more variations on the same or similar value (e.g., “isomorphisms”). These variations can comprise any way of varying the representation of a value, such as by a numerical and textual variation. For example, a single date “19 December” can also be represented identically by “December 19”, “12/19”, “19-12”, “12-19” depending on the environment in which the API 110 will be ultimately implemented. Since it is desirable for Applications and User Interfaces to be portable across several environments, such as by users in several countries, in several languages, and/or several technical environments, advantages can be realized by testing the identified common API 110 with each isomorphism 207 of a given value 205.

By way of further explanation, the number and type of isomorphisms for a given value can be unique from one interface to the next. In particular, one interface may be able to receive or understand five ways of representing a given value, another interface might be able to receive or understand twelve ways of representing the given value, and yet another interface might be able to receive or understand only one or two ways of representing the given value. With reference to the previously described date example, a calendar interface that receives text as the primary user input may be configured to understand as many as 5 textual ways of representing the date December 19, including both numeral (“12”) and spelled-out (“December”) representations of the month portion of the date. By contrast, a voice-based interface that implements the same API may be configured to receive or understand only the commonly spoken versions of the date value, such as “December nineteen”, “December nineteenth”, “nineteenth of December”, and so forth, as opposed to “twelve nineteen”. As such, in at least one implementation of the present invention, the test program can automatically identify isomorphisms 207 of a given value 205 that are interface-specific.

In any case, once the value 205 or set of values is identified, the tester tests the value 205 with the API 110 by entering the value 205 directly into the test program 210 interface at a computerized system, or by instructing another program (not shown) that has the value 205 as its output to electronically relay the value 205 as input into the test program 210. However the value 205 is received by the test program 210, the test program 210 then relays the value 205 from the API 110 to the Application Program to be tested, in this case Application Program 200. After the Application Program 200 receives the value 205 from the test program 210 through the API 110, the Application Program 200 returns a result 215.

Depending on the nature of the results 215, the tester can then determine whether the application program 200 is interoperable with the API 110. If the test program 210 and application program 200 are determined to be interoperable at least in part based on the result 215, the tester will be able to determine that API 110 functions properly, regardless of the user interface that will implement the API 110. Hence, the tester will know that that each of the different interfaces 120, 130, 140, and 150 are each also interoperable with Application Program 200, at least with respect to API 110.

Another aspect of the present invention is that a test program that is written for one API, for example test program 210 written for API 110, does not need to be re-written for any additional given API, such as API 134, which, in accordance with FIG. 1, is common only to user interfaces 130 and 140. The test program 210 can be converted in a conversion module 230 that converts the test program so that it can be run with the different API. In one embodiment, the conversion module 230 takes the source code of the test program 210 and recompiles the source code of the test program 210 such that the test program 210 becomes test program 212, which is built around the new API 134, and/or is configured to test new Application Program 202. Alternatively, conversion module 230 can convert an API call corresponding to a first API for compatibility with a second API at runtime. Similar embodiments are possible for test programs that implement scripting languages rather than compiled source code. In any case, a tester can implement test programs, e.g., 210, 212, for multiple APIs and multiple Application Programs without rewriting the test program 210 from scratch.

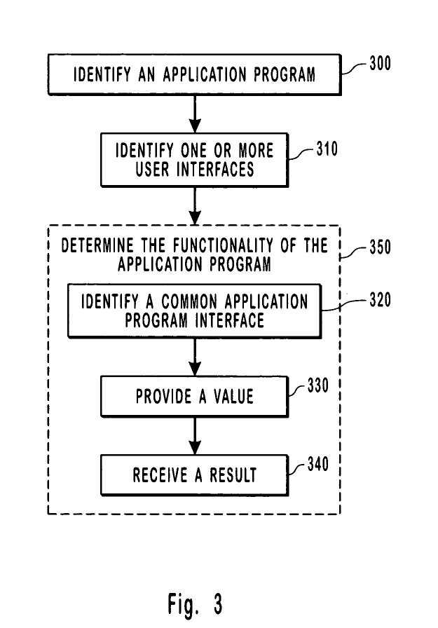

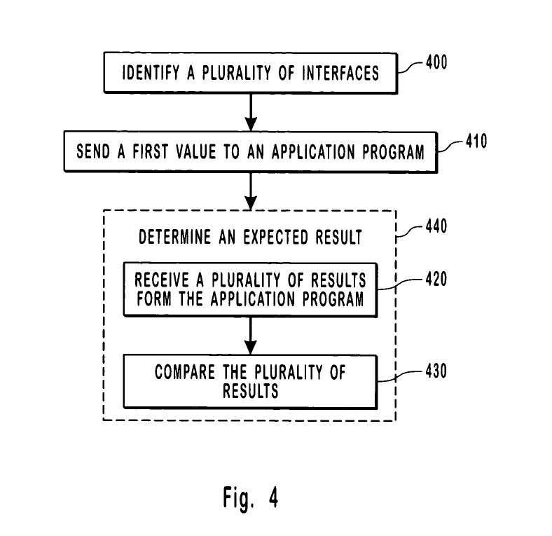

The present invention may also be described in terms of methods, comprising functional steps and/or non-functional acts. FIGS. 3 and 4 illustrate exemplary flow charts of methods for testing computer-executable instructions through each of one or more interfaces using a single testing program in accordance with aspects of the present invention. The methods of FIGS. 3 and 4 will be discussed with respect to the programs and APIs illustrated in FIGS. 1 and 2.

FIG. 3 illustrates a flow chart that can be used in practice with at least one embodiment of the present invention. As illustrated, a method for testing computer-executable instructions through each of one or more interfaces using a single testing program includes an act 300 of identifying an application program. Act 300 can include identifying an application program to be tested. For example, a tester or program developer identifies a recently developed Application Program 100, 200, etc., and desires to test the program extensively before placing the Application Program 100, 200, in the hands of the ultimate user. The method also comprises an act 310 of identifying one or more user interfaces. Act 310 includes identifying one or more user interfaces that are intended to access the application program. For example, a user or a system identifies the user interfaces such as user interface 120, 130, 140, and 150 that are intended to access the application program 100, 200, etc.

The method in accordance with present invention also includes a functional step 350 for determining the functionality of the application program. Step 350 includes determining the functionality of the application program with the one or more user interfaces by using a single testing program that incorporates an application program interface that is common to each of the one or more user interfaces. For example, a tester can determine the operability of each of the identified one or more user interfaces with the identified Application Program to be tested without having to write or rewrite a separate test for each user interface, or other unidentified user interfaces that may implement aspects of the identified user interfaces.

Step 350 can include any number of corresponding acts for implementing the present invention, though, as depicted in FIG. 3, step 350 includes the following acts such as an act 320 of identifying a common application program interface. Act 320 includes identifying an application program interface that is common to each of the one or more interfaces that can access the application program, such that a function of the application program that can be accessed by each of the one or more interfaces can be tested. For example, each device 120, 130, 140, or 150 (or corresponding user interface) will implement an application program that includes a set of APIs such as a set of APIs 122, 132, 142, 152, and so on. A user or testing system will then identify which of the APIs exist commonly in each API set 122, 132, 142, and 152. For example, as shown in FIG. 1, API 110 is the only API that is common to each user interface 120, 130, 140, and 150 although there can be multiple common APIs among each of the different API sets.

Step 350 also comprises an act 330 of providing a value to the application program interface. Act 330 includes providing a first value to the application program through the common application program interface. For example, a tester can provide one or more isomorphisms 207 of a date value 205 into a test program 210 that has been written around the identified common API 110. The test program 210 then provides the value 205, 207 to the application program to be tested 200, 202 by way of the identified common API 110. Further, the step 350 includes an act 340 of receiving a result. Act 340 includes receiving a result from the application program. For example, if an input value 205, 207 includes a numerical date, the output result of entering 12/19 might be a textual equivalent of the numerical value, as well as a list of appointments scheduled for that date, and so forth.

FIG. 4 illustrates a similar method for testing an application program for each of one or more interfaces using a single testing program, although FIG. 4 further illustrates ways to validate testing results in accordance with aspects of the present invention. For example, a method of testing in accordance with the present invention includes an act 400 of identifying a plurality of interfaces. Act 400 includes identifying a plurality of interfaces that are intended to access an application program. For example, a user or a system identifies the user interfaces such as user interface 120, 130, 140, and 150 that are intended to access the application program 100, 200, etc.

The method of FIG. 4 also comprises an act 410 of sending a first value to an application program. Act 410 includes sending a first value to an application program for each of the plurality of identified interfaces, wherein the first value is sent using an application program interface that is common to each of the plurality of identified interfaces. For example, each device 120, 130, 140, or 150 (or corresponding user interface) will implement an application program that includes a set of APIs such as a set of APIs 122, 132, 142, 152, and so on. A user or testing system will then identify which of the APIs exist commonly in each API set 122, 132, 142, and 152. For example, as shown in FIG. 1, API 110 is the only API that is common to each user interface 120, 130, 140, and 150 although there can be multiple common APIs among each of the different API sets.

The method of FIG. 4 also comprises a step 440 for determining an expected result. Step 440 includes determining an expected result based on the result received from the application program for the plurality of interfaces. For example, a tester can implement a test program 210 that includes an identified, common API 110 and that is configured to mimic one or more of the plurality of interfaces (e.g., 120, 130, etc.), such as a test program that receives input from a touchtone keypad for a telephone, etc. Even though the identified common API 110 is the same for each identified interface 120, 130, etc., there may still be different results obtained from one test to the next, particularly if the tester develops the test program 210 to mimic a particular user interface. Accordingly, the tester may wish to observe an expected result by comparing with every test that is run using the identified, common API 110.

Although step 440 can comprise any number or combination of corresponding acts for accomplishing the step 440 depicted in FIG. 4, step 440 comprises act 420 of receiving a plurality of results from the application program. Act 440 includes receiving a plurality of results from the application program, wherein each result in the plurality corresponds to an identified one of the plurality of interfaces. For example, a tester may run a developed test program 210 that has been configured around the identified, common API 110 multiple times, or may further implement the conversion module 230 so that the test program 210 can be configured to mimic other interfaces or APIs (e.g., 134, etc.) and other application programs (e.g., 202) more closely. While, in some embodiments, this can require additional testing, rather than running few or one tests for a given API, this should nevertheless not require rewriting of the test program. For example, a test program 210 can be recompiled automatically into test program 212 for a different interface before running the test. Hence, time and effort is still significantly reduced since the test program 210 does not necessarily need to be rewritten by the tester.

Further, step 440 can also comprise an act 430 of comparing the plurality of results. Act 430 includes comparing the plurality of results to identify an expected result. Thus, for example, after each result has been received, a tester can analyze the results using a variety of methods, such as statistical analyses, and identify the expected result. The expected result can then be used as a baseline of comparison that will be used to validate results of additional tests using the same application program or same API.

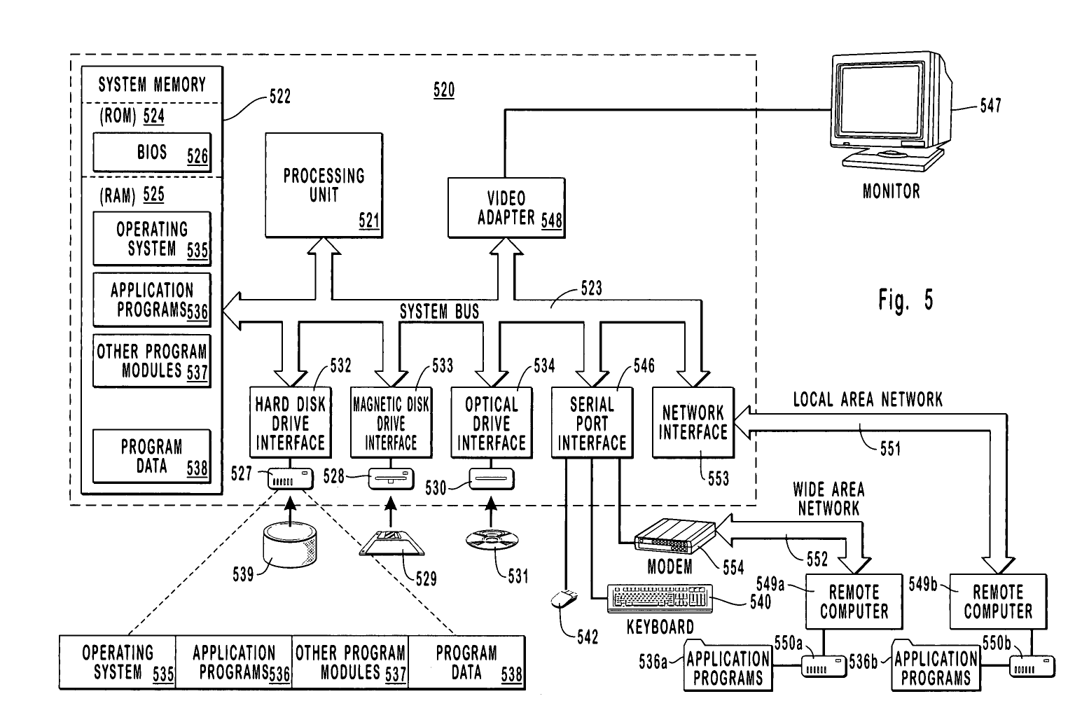

FIG. 5 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, telephonic devices and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 5, an exemplary system for implementing the invention includes a general-purpose computing device in the form of a conventional computer 520, including a processing unit 521, a system memory 522, and a system bus 523 that couples various system components including the system memory 522 to the processing unit 521. The system bus 523 may be any of several types of bus structures including a memory bus or memory controller, a peripheral bus, and a local bus using any of a variety of bus architectures. The system memory includes read only memory (ROM) 524 and random access memory (RAM) 525. A basic input/output system (BIOS) 526, containing the basic routines that help transfer information between elements within the computer 520, such as during start-up, may be stored in ROM 524.

The computer 520 may also include a magnetic hard disk drive 527 for reading from and writing to a magnetic hard disk 539, a magnetic disc drive 528 for reading from or writing to a removable magnetic disk 529, and an optical disc drive 530 for reading from or writing to removable optical disc 531 such as a CD ROM or other optical media. The magnetic hard disk drive 527, magnetic disk drive 528, and optical disc drive 530 are connected to the system bus 523 by a hard disk drive interface 532, a magnetic disk drive-interface 533, and an optical drive interface 534, respectively. The drives and their associated computer-readable media provide nonvolatile storage of computer-executable instructions, data structures, program modules and other data for the computer 520. Although the exemplary environment described herein employs a magnetic hard disk 539, a removable magnetic disk 529 and a removable optical disc 531, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 539, magnetic disk 529, optical disc 531, ROM 524 or RAM 525, including an operating system 535, one or more application programs 536, other program modules 537, and program data 538. A user may enter commands and information into the computer 520 through keyboard 540, pointing device 542, or other input devices (not shown), such as a microphone, joy stick, game pad, satellite dish, scanner, or the like. These and other input devices are often connected to the processing unit 521 through a serial port interface 546 coupled to system bus 523. Alternatively, the input devices may be connected by other interfaces, such as a parallel port, a game port or a universal serial bus (USB). A monitor 547 or another display device is also connected to system bus 523 via an interface, such as video adapter 548. In addition to the monitor, personal computers typically include other peripheral output devices (not shown), such as speakers and printers.

The computer 520 may operate in a networked environment using logical connections to one or more remote computers, such as remote computers 549a and 549b. Remote computers 549a and 549b may each be another personal computer, a server, a router, a network PC, a peer device or other common network node, and typically include many or all of the elements described above relative to the computer 520, although only memory storage devices 550a and 550b and their associated application programs 536a and 536b have been illustrated in FIG. 5. The logical connections depicted in FIG. 5 include a local area network (LAN) 551 and a wide area network (WAN) 552 that are presented here by way of example and not limitation. Such networking environments are commonplace in office-wide or enterprise-wide computer networks, intranets and the Internet.

When used in a LAN networking environment, the computer 520 is connected to the local network 551 through a network interface or adapter 553. When used in a WAN networking environment, the computer 520 may include a modem 554, a wireless link, or other means for establishing communications over the wide area network 552, such as the Internet. The modem 554, which may be internal or external, is connected to the system bus 523 via the serial port interface 546. In a networked environment, program modules depicted relative to the computer 520, or portions thereof, may be stored in the remote memory storage device. It will be appreciated that the network connections shown are exemplary and other means of establishing communications over wide area network 552 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. In a computerized system environment including computer-executable instructions, and one or more interfaces for accessing the computer-executable instructions, a method of testing the computer-executable instructions through each of the one or more interfaces using a single testing program, the method comprising the acts of:
identifying one or more interfaces that are intended to access an identified application program;
identifying an application program interface that is common to each of the one or more interfaces that can access the application program, such that a function of the application program that can be accessed by each of the one or more interfaces can be tested;
providing at least one representation of a first value to the application program through the common application program interface; and
receiving a result from the application program.

2. The method as recited in claim 1, wherein the at least one representation of the first value is unique to at least one of the one or more interfaces.

3. The method as recited in claim 2, wherein the at least one representation of the first value is identified automatically prior to providing the at least one representation to the application program.

4. The method as recited in claim 1, wherein the one or more interfaces includes one or more of a telephone user interface, a graphical user interface, a command-line interface, and a machine-based interface.

5. The method as recited in claim 1, wherein the identified application program is an application program to be tested.

6. The method as recited in claim 1, further comprising generating a test program that is configured to access the identified application program through the identified common application program interface.

7. The method as recited in claim 6, wherein the first value is provided to the application program by the test program through the identified common application program interface.

8. The method as recited in claim 6, further comprising identifying one or more other application program interfaces that are common to the identified user interfaces.

9. The method as recited in claim 8, further comprising converting the test program such that it is configured to access the identified application program through at least one of the one or more other application program interfaces.

10. The method as recited in claim 1, further comprising receiving one or more results from the application program through the corresponding one or more interfaces that are intended to access the application program.

11. The method as recited in claim 10, further comprising, based on the received one or more results, identifying an expected result by which the received one or more results can be compared.

12. In a computerized system environment including computer-executable instructions, and one or more interfaces for accessing the computer-executable instructions, a method of testing the computer-executable instructions through each of the one or more interfaces using a single testing program, the method comprising:
an act of identifying an application program to be tested;
an act of identifying one or more interfaces that are intended to access the application program; and
a step for determining the functionality of the application program with the one or more interfaces by using a single testing program that incorporates an application program interface that is common to each of the one or more interfaces.

13. The method as recited in claim 12, wherein the step for determining the functionality of the application program with the one or more interfaces comprises corresponding the acts of:
identifying an application program interface that is common to each of the one or more interfaces that can access the application program, such that a function of the application program that can be accessed by each of the one or more interfaces can be tested;
providing at least one representation of a first value to the application program through the common application program interface; and
receiving a result from the application program.

14. In a computerized system environment including computer-executable instructions, and one or more interfaces for accessing the computer-executable instructions, a method of testing an application program through each of the one or more interfaces using a single testing program, the method comprising:
identifying a plurality of interfaces that are intended to access an application program;
sending a first value to the application program for each of the plurality of identified interfaces, wherein the first value is sent using an application program interface that is common to each of the plurality of identified interfaces; and
receiving a plurality of results from the application program, wherein each result in the plurality corresponds to an identified one of the plurality of interfaces; and
comparing the plurality of results to identify an expected result.

15. The method as recited in claim 14, further comprising sending a next value to the application program for each of the plurality of identified interfaces.

16. The method as recited in claim 15, further comprising receiving a next result from the application program that is based in part on the next value that has been sent to the application.

17. The method as recited in claim 16, further identifying that the application is interoperable with at least one of the identified interfaces by comparing the next result with the expected result.

18. The method as recited in claim 14, further comprising generating a test program that is configured to access the application program through the identified common application program interface.

19. The method as recited in claim 18, further comprising identifying one or more other application program interfaces that are common to the identified user interfaces.

20. The method as recited in claim 19, further comprising converting the test program such that it is configured to access the identified application program through at least one of the one or more other application program interfaces.

21. In a computerized system environment including computer-executable instructions, and one or more interfaces for accessing the computer-executable instructions, a computer program product having computer-executable code stored thereon that, when executed, causes a computerized system to perform a method of testing an application program through each of the one or more interfaces using a single testing program, the method comprising:
identifying one or more interfaces that are intended to access an identified application program;
identifying an application program interface that is common to each of the one or more interfaces that can access the application program, such that a function of the application program that can be accessed by each of the one or more interfaces can be tested;
providing at least one representation of a first value to the application program through the common application program interface; and
receiving a result from the application program.

22. In a computerized system environment including computer-executable instructions, and one or more interfaces for accessing the computer-executable instructions, a computer program product having computer-executable instructions stored thereon that, when executed, cause a computerized system to perform a method of testing an application program through each of the one or more interfaces using a single testing program, the method comprising:
identifying a plurality of interfaces that are intended to access an application program;
sending a first value to the application program for each of the plurality of identified interfaces, wherein the first value is sent using an application program interface that is common to each of the plurality of identified interfaces; and
receiving a plurality of results from the application program, wherein each result in the plurality corresponds to an identified one of the plurality of interfaces; and
comparing the plurality of results to identify an expected result.
